(19) United States
(12) Patent Application Publication
(10) Pub. No.: US 2013/0260699 A1
(43) Pub. Date: Oct. 3, 2013

(54) GENERATING TEST MEASUREMENT VALUES FOR AUTOMATIC CALIBRATION USING AN INTERNAL TESTING LOAD

(71) Applicant: QUALCOMM INCORPORATED, San Diego, CA (US)

(72) Inventors: Udara C. Fernando, San Diego, CA (US); Puay H. See, San Diego, CA (US); Sudarsan Krishnan, San Diego, CA (US)

(73) Assignee: QUALCOMM INCORPORATED, San Diego, CA (US)

(21) Appl. No.: 13/645,245

(22) Filed: Oct. 4, 2012

Related U.S. Application Data
(60) Provisional application No. 61/618,490, filed on Mar. 30, 2012.

(51) Int. Cl. H04B 1/44

(52) U.S. Cl. 455/79

(57) ABSTRACT

A wireless communication device configured for automatic calibration is described. The wireless communication device includes a testing load. The wireless communication device also includes a transceiver chip. The wireless communication device further includes a radio frequency connector switch that couples circuitry on the transceiver chip to one of the testing load, an external load and a radiating element.

### CLAIM OF PRIORITY UNDER 35 U.S.C. §119

The present application for patent claims priority to Provisional Application No. 61/618,490, entitled “Generating test measurement values for automatic calibration using an internal testing load” filed Mar. 30, 2012, and assigned to the assignee hereof and hereby expressly incorporated by reference herein.

### TECHNICAL FIELD

The present disclosure relates generally to wireless devices for communication systems. More specifically, the present disclosure relates to systems and methods for generating test measurement values for automatic calibration using an internal testing load.

### BACKGROUND

Wireless communication systems have become an important means by which many people worldwide have come to communicate. A wireless communication system may provide communication for a number of subscriber stations, each of which may be serviced by a base station.

Subscriber stations are typically calibrated in the factory to ensure that the subscriber stations meet stringent manufacturing requirements. During calibration, a voice call may be performed using the subscriber station. Typically, calibration is performed using an external call box. Due to the complexity of circuitry within a wireless communication device, such calibration may be time consuming and factory throughput may be reduced. Benefits may be realized by improvements to the calibration of subscriber stations in the factory.

### SUMMARY

A wireless communication device configured for automatic calibration is described. The wireless communication device includes an internal testing load. The wireless communication device also includes a transceiver chip. The wireless communication device further includes a radio frequency connector switch that couples circuitry on the transceiver chip to one of the internal testing load, an external load and a radiating element.

The wireless communication device may collect test measurement values when the radio frequency connector switch couples the transceiver chip to the internal testing load. The external load may be a call box. The wireless communication device may provide the test measurement values to the call box when the radio frequency connector switch couples the transceiver chip to the call box. The test measurement values may include Rx automatic calibration test measurement values and Tx automatic calibration test measurement values.

The transceiver chip may include a transmitter, a primary receiver. a secondary receiver and a tone generator. The radio frequency connector switch may couple the circuitry on the transceiver chip to one of the internal testing load, the external load and the tone generator. The tone generator may include a phase lock loop, a voltage controlled oscillator, a drive amplifier and one or more attenuators. The tone generator can pass a generated signal through the one or more attenuators to scale the generated signal.

The tone generator may include a temperature compensated crystal oscillator, an Rx local oscillator, a divide by M circuit, a mixer and one or more attenuators. The temperature compensated crystal oscillator, the Rx local oscillator and the divide by M circuit may be reused from circuitry on the transceiver chip.

The tone generator may include a phase lock loop. The tone generator may also include a voltage controlled oscillator. The phase lock loop and voltage controlled oscillator may form a feedback loop. The tone generator may also include one or more attenuators.

The transceiver chip may also include a tone generator switch that couples a coupler on the wireless communication device to one of the tone generator and the secondary receiver. The tone generator switch may couple the tone generator to the coupler. The radio frequency connector switch may couple the transceiver chip to the internal testing load. Rx automatic calibration test measurement values may be collected by generating a tone using the tone generator and measuring a response through the internal testing load using the primary receiver.

The tone generator switch may couple the secondary receiver to the coupler. The radio frequency connector may couple the transceiver chip to the internal testing load. Tx automatic calibration test measurement values may be collected by generating a transmit signal using the transmitter and measuring a response through the internal testing load using the secondary receiver.

The test measurement values may include power versus frequency versus gain delta values. The test measurement values may be calculated autonomously by the wireless communication device prior to calibration by a call box. The radiating element may be an antenna. The radio frequency connector switch may be configured so that the transceiver chip is coupled to the internal testing load when the external load is not connected to the wireless communication device and so that the transceiver chip is coupled to the external load when the external load is connected to the wireless communication device. The internal testing load may be a 50Ω testing load.

A method for generating test measurement values by a wireless communication device is also described. Circuitry in the wireless communication device is coupled to an internal testing load. Test measurement values are generated using the internal testing load. The circuitry in the wireless communication device is coupled to a call box. The test measurement values are provided to the call box.

Generating test measurement values using the internal testing load may include generating a tone using a tone generator and measuring a response through the internal testing load using a primary receiver. The response may include Rx automatic calibration test measurement values. Generating test measurement values using the internal testing load may also include generating a transmit signal using a transmitter and measuring a response through the internal testing load using a secondary receiver. The response may include Tx automatic calibration test measurement values.

An apparatus for generating test measurement values is described. The apparatus includes means for coupling circuitry in the apparatus to an internal testing load. The apparatus also includes means for generating test measurement values using the internal testing load. The apparatus further includes means for coupling the circuitry in the apparatus to a call box. The apparatus also includes means for providing the test measurement values to the call box.

A computer-program product for generating test measurement values is also described. The computer-program product includes a non-transitory computer-readable medium having instructions thereon. The instructions include code for causing a wireless communication device to couple circuitry in the wireless communication device to an internal testing load. The instructions also include code for causing the wireless communication device to generate test measurement values using the internal testing load. The instructions further include code for causing the wireless communication device to couple the circuitry in the wireless communication device to a call box. The instructions also include code for causing the wireless communication device to provide the test measurement values to the call box.

### BRIEF DESCRIPTION OF THE DRAWINGS

FIG. 1 shows a wireless communication device for use in the present systems and methods;

FIG. 2 is a block diagram illustrating a wireless communication device that includes a radio frequency (RF) connecter switch and a testing load;

FIG. 3 is a flow diagram of a method for generating test measurement values using an internal testing load;

FIG. 4 is a block diagram illustrating a wireless communication device while collecting Tx automatic calibration test measurement values;

FIG. 5 is a block diagram illustrating a wireless communication device while collecting Rx automatic calibration test measurement values;

FIG. 6 is a block diagram illustrating a radio frequency (RF) connector switch in a closed position on a wireless communication device;

FIG. 7 is a block diagram illustrating a radio frequency (RF) connector switch in an open position on a wireless communication device;

FIG. 8 is a block diagram illustrating a tone generator for use in the present systems and methods;

FIG. 9 is a block diagram illustrating another tone generator for use in the present systems and methods;

FIG. 10 is a block diagram illustrating yet another tone generator for use in the present systems and methods;

FIG. 11 is a block diagram illustrating another wireless communication device that includes a radio frequency (RF) connecter switch and a testing load;

FIG. 12 illustrates certain components that may be included within a wireless communication device;

FIG. 13 is a block diagram illustrating a wireless communication device for use in the present systems and methods;

FIG. 14 is a block diagram illustrating another wireless communication device for use in the present systems and methods; and

FIG. 15 is a block diagram illustrating yet another wireless communication device for use in the present systems and methods.

### DETAILED DESCRIPTION

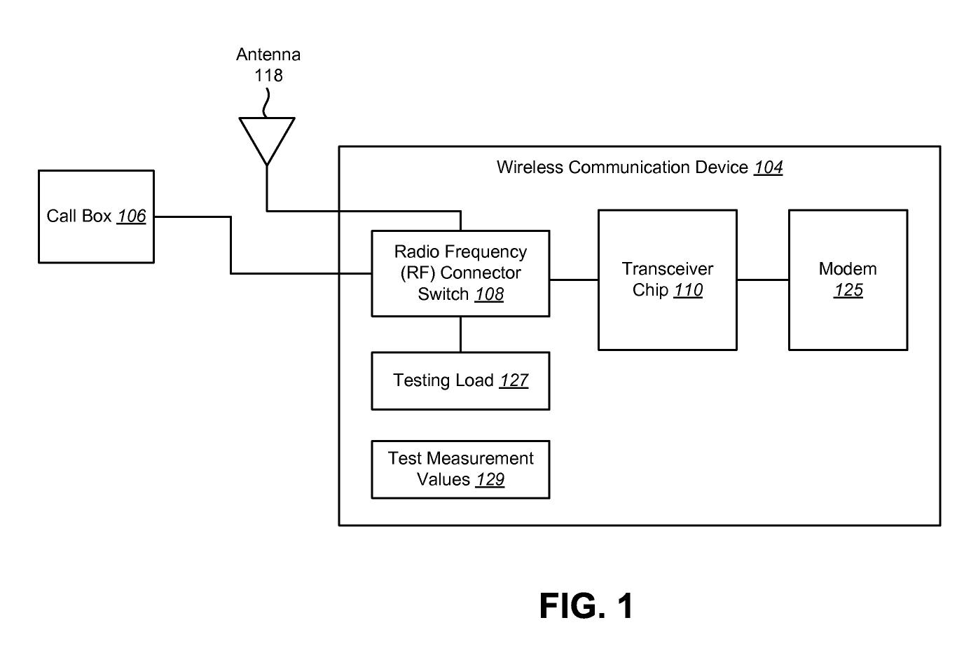

FIG. 1 shows a wireless communication device 104 for use in the present systems and methods. A wireless communication device 104 may also be referred to as, and may include some or all of the functionality of, a terminal, an access terminal, a user equipment (UE), a subscriber unit, a station, etc. A wireless communication device 104 may be a cellular phone, a personal digital assistant (PDA), a wireless device, a wireless modem, a handheld device, a laptop computer, a PC card, compact flash, an external or internal modem, a wireline phone, etc. A wireless communication device 104 may be mobile or stationary. A wireless communication device 104 may communicate with zero, one or multiple base stations on a downlink and/or an uplink at any given moment. The downlink (or forward link) refers to the communication link from a base station to a wireless communication device 104, and the uplink (or reverse link) refers to the communication link from a wireless communication device 104 to a base station. Uplink and downlink may refer to the communication link or to the carriers used for the communication link.

A wireless communication device 104 may operate in a wireless communication system that includes other wireless devices, such as base stations. A base station is a station that communicates with one or more wireless communication devices 104. A base station may also be referred to as, and may include some or all of the functionality of, an access point, a broadcast transmitter, a Node B, an evolved Node B, etc. Each base station provides communication coverage for a particular geographic area. A base station may provide communication coverage for one or more wireless communication devices 104. The term “cell” can refer to a base station and/or its coverage area, depending on the context in which the term is used.

Communications in a wireless communication system (e.g., a multiple-access system) may be achieved through transmissions over a wireless link. Such a communication link may be established via a single-input and single-output (SISO) or a multiple-input and multiple-output (MIMO) system. A multiple-input and multiple-output (MIMO) system includes transmitter(s) and receiver(s) equipped, respectively, with multiple (NT) transmit antennas and multiple (NR) receive antennas for data transmission. SISO systems are particular instances of a multiple-input and multiple-output (MIMO) system. The multiple-input and multiple-output (MIMO) system can provide improved performance (e.g., higher throughput, greater capacity or improved reliability) if the additional dimensionalities created by the multiple transmit and receive antennas are utilized.

The wireless communication system may utilize both single-input and multiple-output (SIMO) and multiple-input and multiple-output (MIMO). The wireless communication system may be a multiple-access system capable of supporting communication with multiple wireless communication devices 104 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, single-carrier frequency division multiple access (SC-FDMA) systems, 3^{rd} Generation Partnership Project (3GPP) Long Term Evolution (LTE) systems and spatial division multiple access (SDMA) systems.

Each wireless communication device 104 is calibrated in the factory for accurate transmit and receive power levels using a call box 106. Because there are lots of power points to calibrate in the factory before test, it may take 2-3 minutes for automatic calibration of a wireless communication device 104 by a call box 106. By reducing the amount of time required to calibrate a wireless communication device 104 by a call box 106, factory throughput may be increased and production costs may be reduced.

To reduce the amount of time required to calibrate a wireless communication device 104 by a call box 106, the wireless communication device 104 may include a testing load 127. The testing load 127 may allow the wireless communication device 104 to perform an automatic calibration (also referred to as self-calibration). In one configuration, the testing load 127 may be 50Ω. The testing load 127 may be located on the wireless communication device 104 (e.g., on a printed circuit board (PCB) in the wireless communication device 104).

The wireless communication device 104 may include a radio frequency (RF) connector switch 108. The radio frequency (RF) connector switch 108 may be coupled to a transceiver chip 110 on the wireless communication device 104. The radio frequency (RF) connector switch 108 may couple the transceiver chip 110 to one of an antenna 118 on the wireless communication device 104, the testing load 127 on the wireless communication device 104 or an external call box 106. Thus, the radio frequency (RF) connector switch 108 may allow the wireless communication device 104 to perform automatic calibration using the testing load 127 prior to calibration performed using the call box 106. The transceiver chip 110 may be coupled to a modem 125 on the wireless communication device 104.

During automatic calibration, the wireless communication device 104 may generate test measurement values 129. The test measurement values 129 may include power versus frequency versus gain values. More specifically, the test measurement values 129 may indicate the power versus frequency versus gain delta values (i.e., the difference in measured values from expected values due to manufacturing variability of the wireless communication device 104). If the wireless communication device 104 includes a testing load 127, the test measurement values 129 may be calculated autonomously by the wireless communication device 104 prior to calibration by the call box 106. The wireless communication device 104 may provide the test measurement values 129 to a call box 106 when the wireless communication device 104 is coupled to the call box 106 during automatic calibration. Along with receiving the test measurement values 129, the call box 106 may perform a “one point” power measurement on the wireless communication device 104 to obtain an absolute power table. The amount of time that a wireless communication device 104 needs to be coupled to a call box 106 for automatic calibration may be reduced from 2-3 minutes to 2-3 seconds by including a testing load 127 on the wireless communication device 104. Since the call box 106 is full duplex, single point Tx power measurement and Rx power measurement can occur simultaneously.

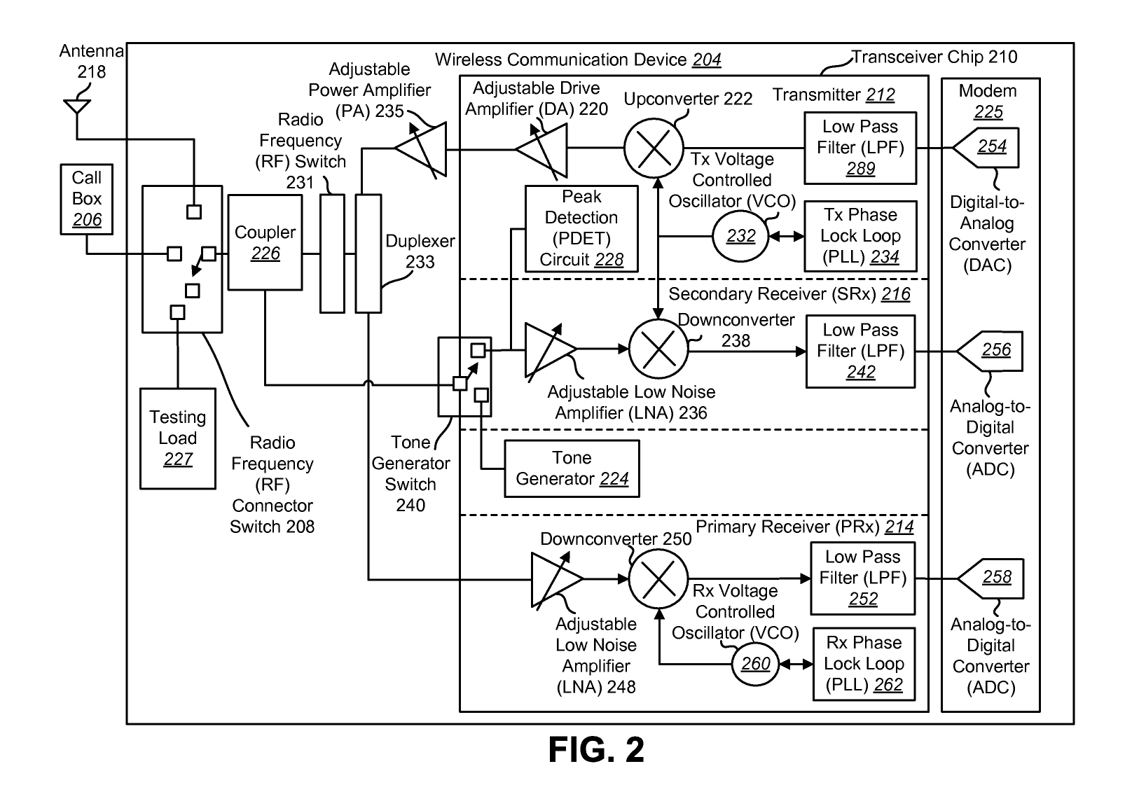

FIG. 2 is a block diagram illustrating a wireless communication device 204 that includes a radio frequency (RF) connecter switch 208 and a testing load 227. The wireless communication device 204 of FIG. 2 may be one configuration of the wireless communication device 104 of FIG. 1. The radio frequency (RF) connector switch 208 may allow circuitry on the wireless communication device 204 to couple to a call box 206, an antenna 218 or the testing load 227.

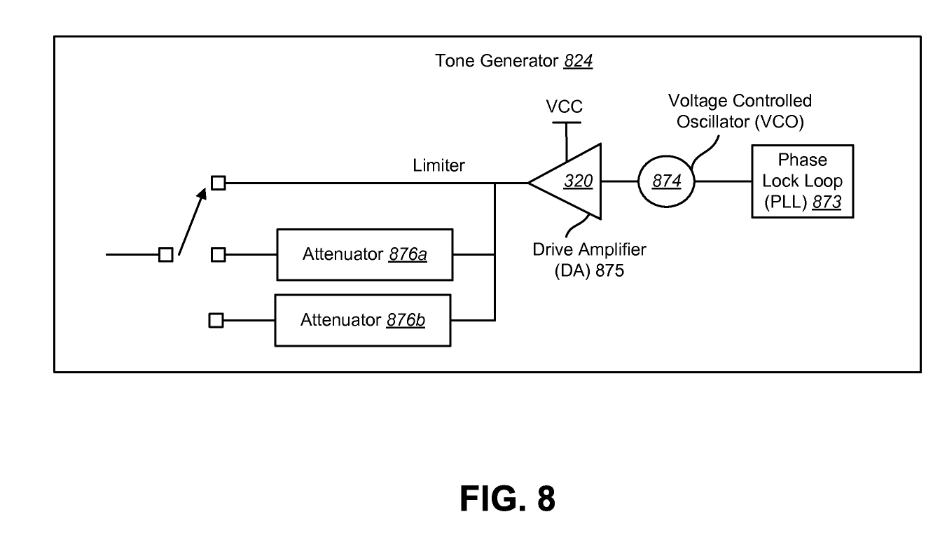

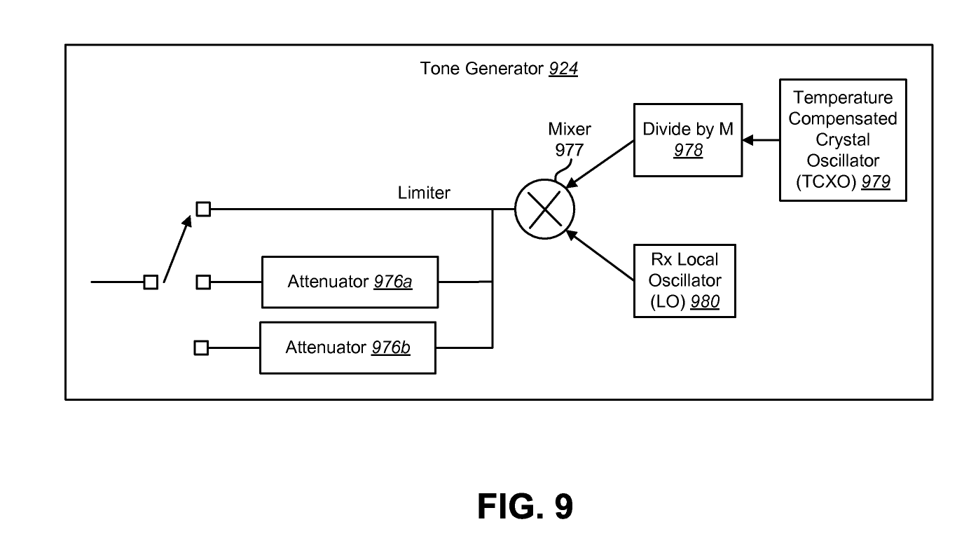

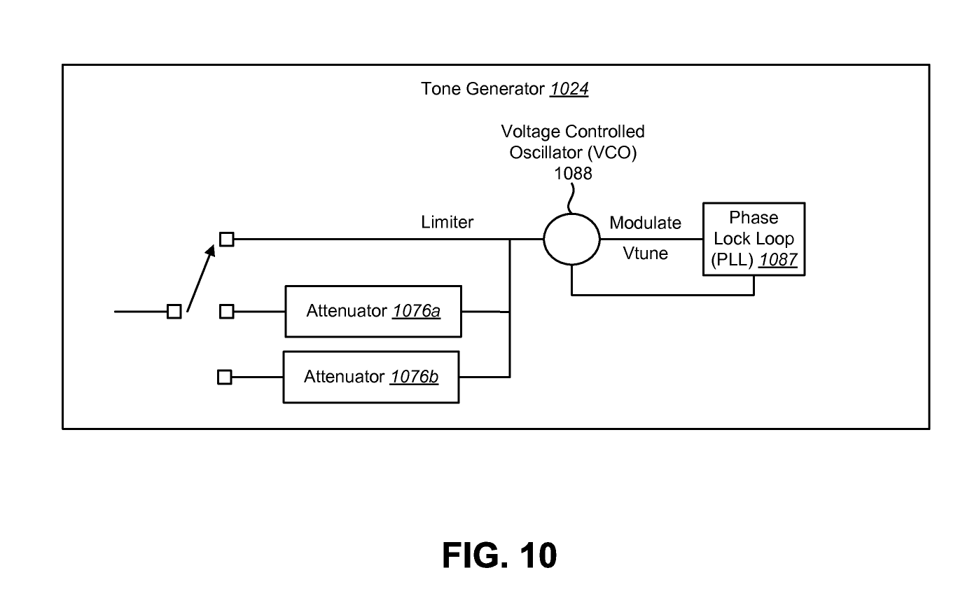

The wireless communication device 204 may include a coupler 226. The coupler 226 may be coupled to the radio frequency (RF) connector switch 208. The coupler 226 may also be coupled to a radio frequency (RF) switch 231 and a tone generator switch 240. The tone generator switch 240 may be located on a transceiver chip 210 in the wireless communication device 204. The tone generator switch 240 may allow the coupler 226 to be coupled to either a secondary receiver (SRx) 216 on the transceiver chip 210 or a tone generator 224 on the transceiver chip 210. In one configuration, the secondary receiver (SRx) 216 may be referred to as a feed-back receiver (FBR). The response of the feed-back receiver (FBR) may be assumed to be constant and the dynamic range limited so that the lower part of the full Tx dynamic range can be covered by a peak detection (PDET) circuit 228 on the transceiver chip 210. The peak detection (PDET) circuit 228 may be coupled to the input of an adjustable low noise amplifier (LNA) 236 in the secondary receiver (SRx) 216. The feed-back receiver (FBR) may have one gain state. The tone generator is discussed in additional detail below in relation to FIG. 8, FIG. 9 and FIG. 10.

The transceiver chip 210 may include a transmitter 212, a primary receiver (PRx) 214 and the secondary receiver (SRx) 216. The transmitter 212 may receive a transmit signal from a digital-to-analog converter (DAC) 254 on a modem 225 on the wireless communication device 204. The transmit signal may be passed through a low pass filter (LPF) 289 before being upconverted to a transmit frequency by an upconverter 222. The transmitter 212 may include a Tx phase lock loop (PLL) 234 and a Tx voltage controlled oscillator (VCO) 232 that are used to generate a Tx local oscillator (LO) signal. The Tx local oscillator (LO) signal may be provided to the upconverter 222.

The upconverted transmit signal may then be amplified by an adjustable drive amplifier (DA) 220. The output of the adjustable drive amplifier (DA) 220 may be coupled to the input of an adjustable power amplifier (PA) 235. The adjustable power amplifier (PA) 235 may not be on the transceiver chip 210.

The output of the adjustable power amplifier (PA) 235 may be coupled to a duplexer 233. The duplexer 233 may utilize frequency selectivity to provide isolation between the transmitter 212 and the primary receiver (PRx) 214. The duplexer 233 may also be coupled to an adjustable low noise amplifier (LNA) 248 on the primary receiver (PRx) 214. The duplexer 233 may further be coupled to the radio frequency (RF) switch 231.

The primary receiver (PRx) 214 may also include a downconverter 250. The downconverter 250 may be coupled to an output of the adjustable low noise amplifier (LNA) 248. The downconverter 250 may receive a downconverting signal generated by an Rx voltage controlled oscillator (VCO) 260 and an Rx phase lock loop (PLL) 262. The output of the downconverter 250 may be coupled to a low pass filter (LPF) 252. The output of the low pass filter (LPF) 252 may be coupled to an analog-to-digital converter (ADC) 258 on the modem 225.

The secondary receiver (SRx) 216 may include an adjustable low noise amplifier (LNA) 236. The input to the adjustable low noise amplifier (LNA) 236 may be coupled via the tone generator switch 240 to the coupler 226. Thus, when the tone generator switch 240 is switched to the secondary receiver (SRx) 216, the coupler 226 may be coupled to the adjustable low noise amplifier (LNA) 236. The output of the adjustable low noise amplifier (LNA) 236 may be coupled to a downconverter 238. The downconverter 238 may receive the Tx local oscillator (LO) signal from the Tx voltage controlled oscillator (VCO) 232 and Tx phase lock loop (PLL) 234. Thus, the secondary receiver (SRx) 216 may share the synthesizer used by the transmitter 212.

The output of the downconverter 238 may be coupled to a low pass filter (LPF) 242. The output of the low pass filter (LPF) 242 may be coupled to an analog-to-digital converter (ADC) 256 on the modem 225. Both the call box 206 and the modem 225 may collect test data (such as test measurement values 129). Some of the test data may be stored in non-volatile memory on the wireless communication device 204.

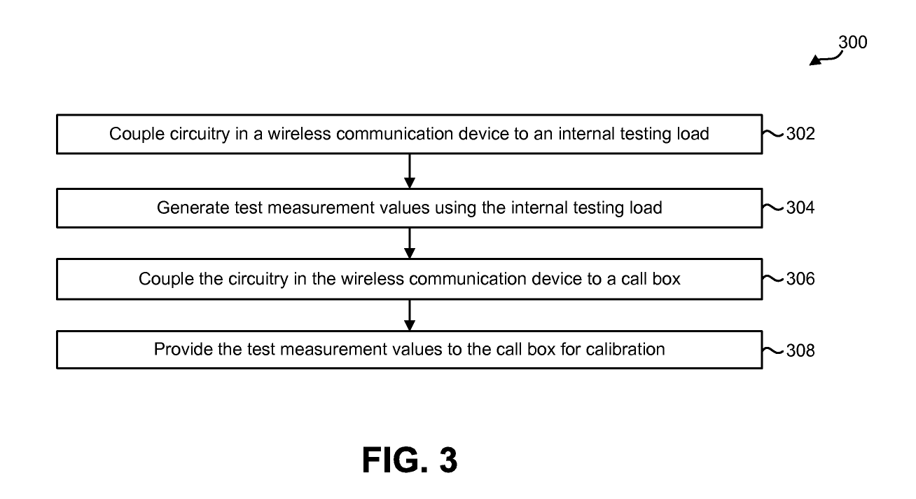

FIG. 3 is a flow diagram of a method 300 for generating test measurement values 129 using an internal testing load 127. The method 300 may be performed by a wireless communication device 104. The wireless communication device 104 may include an internal testing load 127. Circuitry in the wireless communication device 104 may be coupled 302 to the internal testing load 127. The circuitry in the wireless communication device 104 may include a transceiver chip 110. The wireless communication device 104 may then generate 304 test measurement values 129 using the internal testing load 127.

The circuitry in the wireless communication device 104 may next be coupled 306 to a call box 106. Thus, the circuitry in the wireless communication device 104 may not be coupled to the internal testing load 127. In one configuration, a radio frequency (RF) connector switch 108 may be used to couple the circuitry in the wireless communication device 104 to either the testing load 127 or the call box 106. The radio frequency (RF) connector switch 108 may prevent the circuitry in the wireless communication device 104 from being coupled to both the call box 106 and the internal testing load 127. The wireless communication device may provide 308 the test measurement values 129 to the call box 106 for calibration.

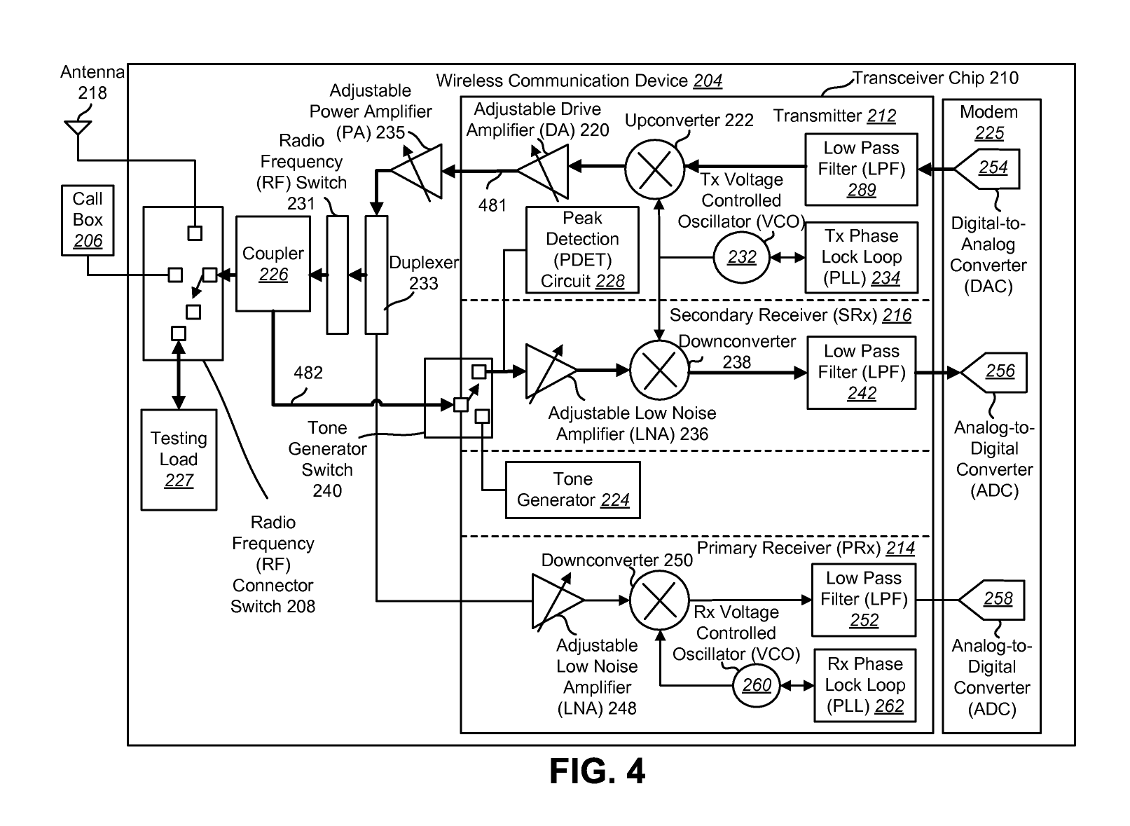

FIG. 4 is a block diagram illustrating a wireless communication device 204 while collecting Tx automatic calibration test measurement values 129. The wireless communication device 204 of FIG. 4 may be the wireless communication device 204 of FIG. 2. When the wireless communication device 204 is collecting Tx automatic calibration test measurement values 129, the radio frequency (RF) connector switch 208 may be set to couple the coupler 226 (and thus the transceiver chip 210) to the testing load 227. The tone generator switch 240 may be set to couple the coupler 226 to the secondary receiver (SRx) 216. Thus, the tone generator 224 is not active.

While collecting Tx automatic calibration test measurement values 129, the transmitter 212 and the secondary receiver (SRx) 216 may both be active. A routing 481 through the transmitter 212 to the testing load 227 is illustrated. A routing 482 from the coupler 226 through the secondary receiver (SRx) 216 is also illustrated. The modem 225 may collect Tx automatic calibration test measurement values 129 by measuring the response of the transmit signal through the testing load 227. The response may be measured using the secondary receiver (SRx) 216.

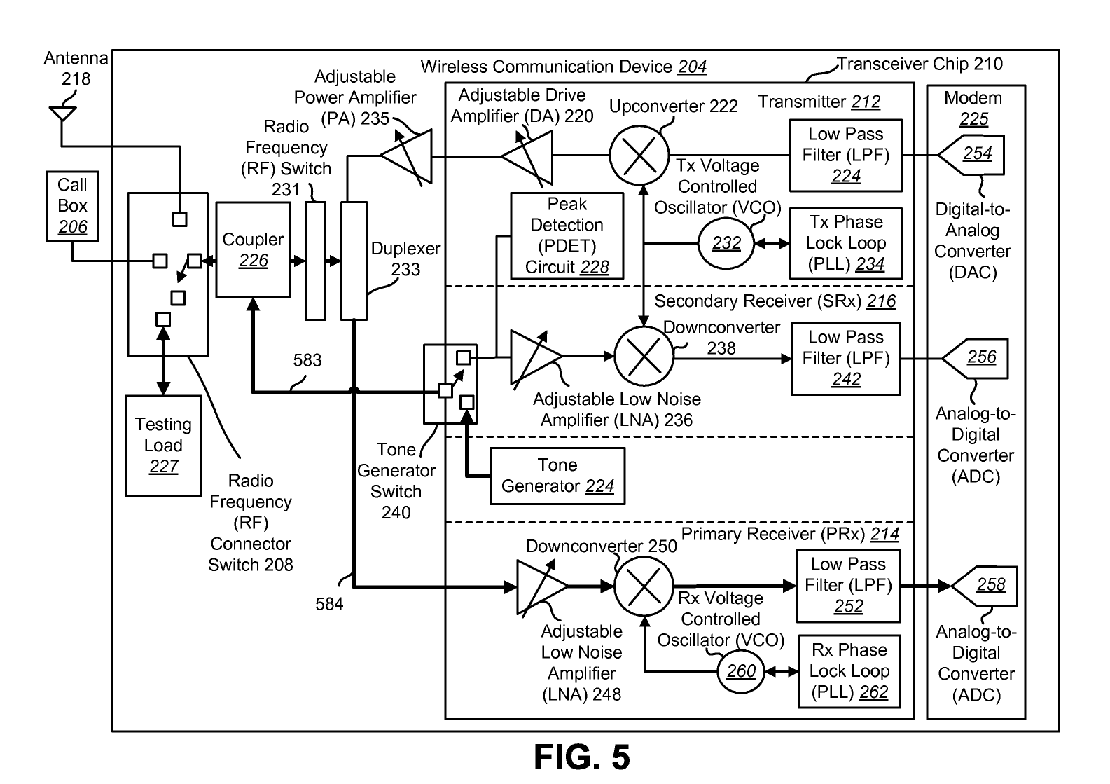

FIG. 5 is a block diagram illustrating a wireless communication device 204 while collecting Rx automatic calibration test measurement values 129. The wireless communication device 204 of FIG. 5 may be the wireless communication device 204 of FIG. 2. When the wireless communication device 204 is collecting Rx automatic calibration test measurement values 129, the radio frequency (RF) connector switch 208 may be set to couple the coupler 226 (and thus the transceiver chip 210) to the testing load 227. The tone generator switch 240 may be set to couple the coupler 226 to the tone generator 224. Thus, the tone generator 224 may be active.

While collecting Rx automatic calibration test measurement values 129, the tone generator 224 and the primary receiver (PRx) 214 may both be active. A routing 583 from the tone generator 224 to the testing load 227 is illustrated. A routing 584 from the testing load 227 to the modem 225 through the primary receiver (PRx) 214 is also illustrated.

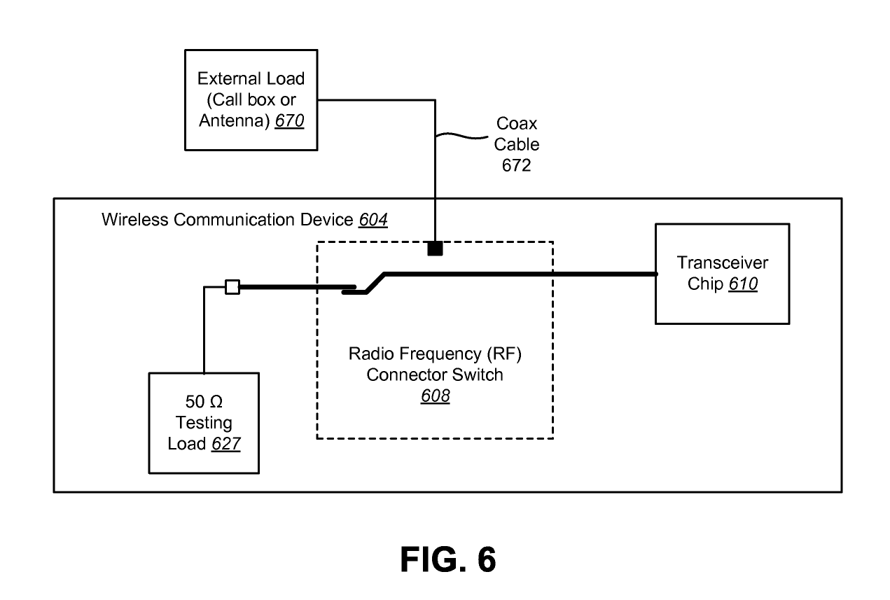

FIG. 6 is a block diagram illustrating a radio frequency (RF) connector switch 608 in a closed position on a wireless communication device 604. The radio frequency (RF) connector switch 608 of FIG. 6 may be one configuration of the radio frequency (RF) connector switch 108 of FIG. 1. The radio frequency (RF) connector switch 608 may be in a closed position when an external load 670 (such as a call box 106 or an antenna 118) is not connected to the wireless communication device 604 via a coax cable 672. For example, the radio frequency (RF) connector switch 608 may be in the closed position when the wireless communication device 604 is collecting Tx automatic calibration test measurement values 129 and/or Rx automatic calibration test measurement values 129.

The wireless communication device 604 may include a 50Ω testing load 627 and a transceiver chip 610. When the radio frequency (RF) connector switch 608 is in the closed position, the radio frequency (RF) connector switch 608 may couple the 50Ω testing load 627 to the transceiver chip 610. The 50Ω testing load 627 may be placed in the wireless communication device 604 such that the transceiver chip 610 is permanently coupled to the 50Ω testing load 627 unless an external load 670 (such as a call box 106 or an antenna 118) is connected to the wireless communication device 604.

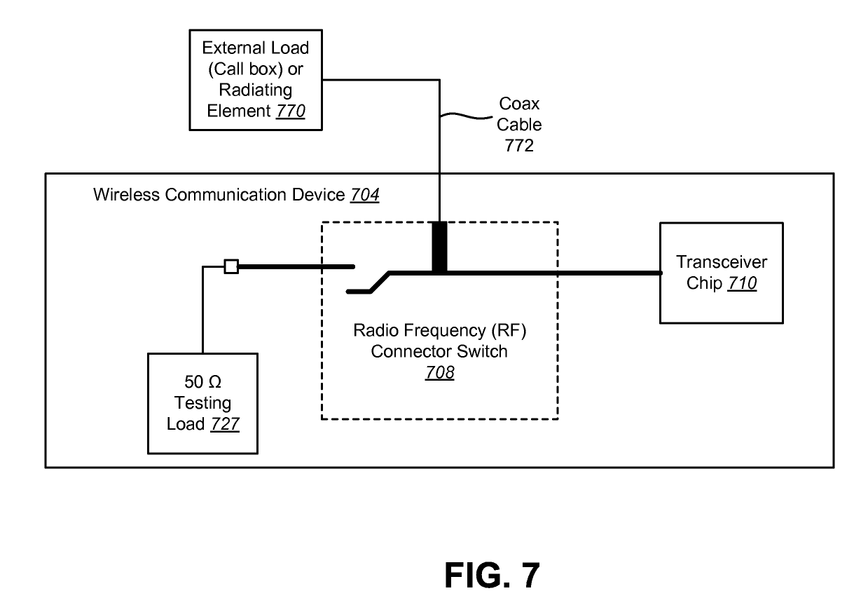

FIG. 7 is a block diagram illustrating a radio frequency (RF) connector switch 708 in an open position on a wireless communication device 704. The radio frequency (RF) connector switch 708 of FIG. 7 may be one configuration of the radio frequency (RF) connector switch 108 of FIG. 1. The radio frequency (RF) connector switch 708 may be in an open position when an external load 770 (such as a call box 106) or a radiating element (such as an antenna 118) is connected to the wireless communication device 704 via a coax cable 772. The radio frequency (RF) connector switch 708 may be designed such that the connection of an external load 770 or radiating element to the wireless communication device 704 places the radio frequency (RF) connector switch 708 in the open position.

The wireless communication device 704 may include a 50Ω testing load 727 and a transceiver chip 710. When the radio frequency (RF) connector switch 708 is in the open position, the radio frequency (RF) connector switch 708 may couple the transceiver chip 710 to the external load 770 or radiating element. The 50Ω testing load 727 may remain in the wireless communication device 704 when an external load 770 or radiating element is connected to the wireless communication device 704; the 50Ω testing load 727 may be an open circuit when an external load 770 or radiating element is connected to the wireless communication device 704.

FIG. 8 is a block diagram illustrating a tone generator 824 for use in the present systems and methods. The tone generator 824 of FIG. 8 may be one configuration of the tone generator 224 of FIG. 2. The tone generator 824 may include a limiter circuit. To improve the dynamic range calibration of Rx receivers, the limiter circuit may include discrete fixed resistive attenuators 876a-b to scale the output signal strength of the tone generator 824.

The tone generator 824 may include a drive amplifier (DA) 875 coupled between the limiter circuit and a voltage controlled oscillator (VCO) 874. The voltage controlled oscillator (VCO) 874 may be coupled to a phase lock loop (PLL) 873. The voltage controlled oscillator (VCO) 874 and the phase lock loop (PLL) 873 may generate a tone. Depending on the requirements of the receiver for collecting Rx automatic calibration test measurement values 129, the tone generated may be output from the tone generator 824 (without being passed through an attenuator 876) or output from the tone generator 824 after being passed through an attenuator 876.

FIG. 9 is a block diagram illustrating another tone generator 924 for use in the present systems and methods. The tone generator 924 of FIG. 9 may be one configuration of the tone generator of FIG. 2. To reduce hardware complexity due to extra phase lock loops (PLLs) and voltage controlled oscillators (VCOs) for the tone generator 924, the tone may instead by generated by reusing a Rx local oscillator (LO) 980, a temperature compensated crystal oscillator (TCXO) 979 and a divide by M circuit 978. The output of the temperature compensated crystal oscillator (TCXO) 979 may be passed through the divide by M circuit 978. The output of the divide by M circuit 978 may be mixed with the output of the Rx local oscillator (LO) 980 by a mixer 977. The mixer 977 may then output the generated tone. The tone generator 924 may also include a limiter circuit. To improve the dynamic range calibration of Rx receivers, the limiter circuit may include discrete fixed resistive attenuators 976a-b to scale the output signal strength of the tone generator 924.

FIG. 10 is a block diagram illustrating yet another tone generator 1024 for use in the present systems and methods. The tone generator 1024 of FIG. 10 may be one configuration of the tone generator 224 of FIG. 2. Rather than including a drive amplifier (DA), the tone generator 1024 may instead include a feedback loop between the phase lock loop (PLL) 1087 and the voltage controlled oscillator (VCO) 1088. A modulate signal may be provided to the voltage controlled oscillator (VCO) 1088 by the phase lock loop (PLL) 1087. The voltage controlled oscillator (VCO) 1088 may then provide a Vtune signal to the phase lock loop (PLL) 1087 as feedback.

The output of the voltage controlled oscillator (VCO) 1088 may be provided to a limiter circuit. The limiter circuit may include one or more discrete fixed resistive attenuators 1076a-b that scale the output signal of the tone generator 1024. Thus, depending on the signal requirements of an Rx receiver, the signal generated by the voltage controlled oscillator (VCO) 1088 may be passed through an attenuator 1076 prior to being output by the tone generator 1024.

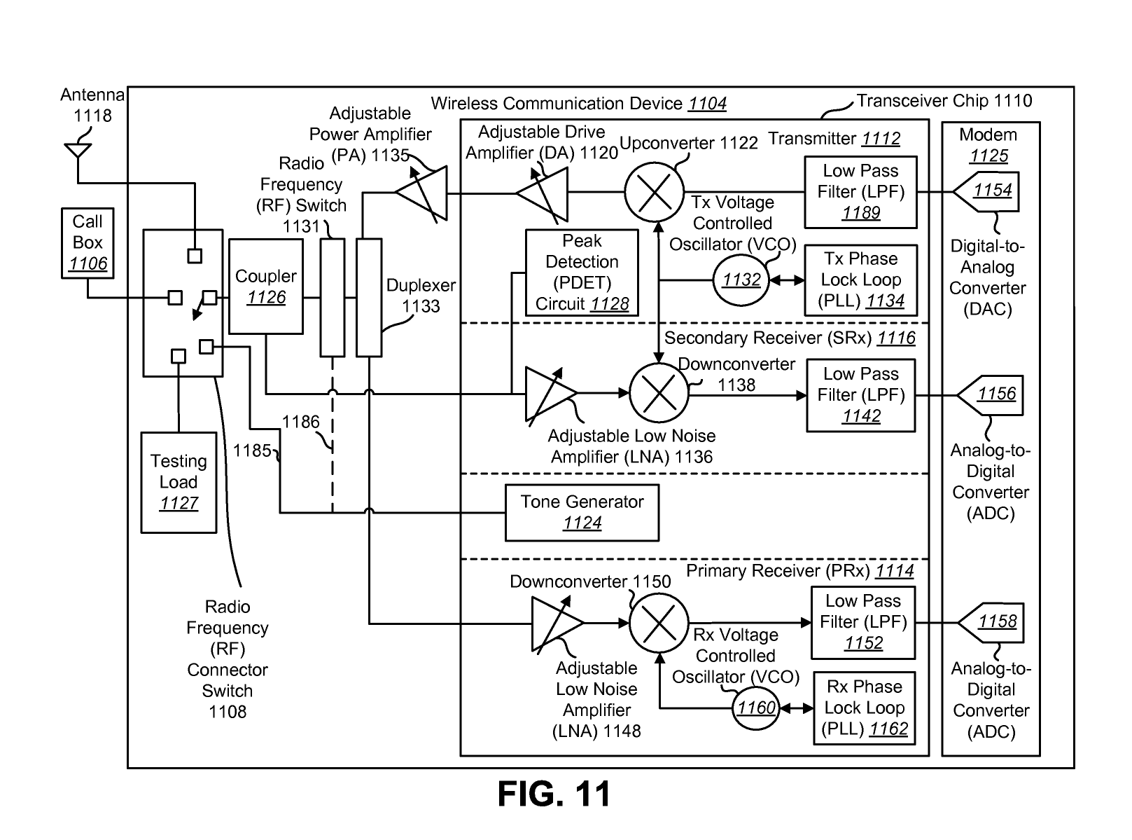

FIG. 11 is a block diagram illustrating another wireless communication device 1104 that includes a radio frequency (RF) connecter switch 1108 and a testing load 1127. The wireless communication device 1104 of FIG. 11 may be one configuration of the wireless communication device 104 of FIG. 1. The radio frequency (RF) connector switch 1108 may allow circuitry on the wireless communication device 1104 to couple to a call box 1106, an antenna 1118 or the testing load 1127.

The wireless communication device 1104 may include a coupler 1126. The coupler 1126 may be coupled to the radio frequency (RF) connector switch 1108. The coupler 1126 may also be coupled to a radio frequency (RF) switch 1131 and a secondary receiver (SRx) 1116. The secondary receiver (SRx) 1116 may be located on a transceiver chip 1110 in the wireless communication device 1104. In one configuration, the secondary receiver (SRx) 1116 may be referred to as a feed-back receiver (FBR). The response of the feed-back receiver (FBR) may be assumed to be constant and the dynamic range limited so that the lower part of the full Tx dynamic range can be covered by a peak detection (PDET) circuit 1128 on the transceiver chip 1110. The peak detection (PDET) circuit 1128 may be coupled to the input of an adjustable low noise amplifier (LNA) 1136 in the secondary receiver (SRx) 1116.

The transceiver chip 1110 may include a transmitter 1112, a primary receiver (PRx) 1114 and the secondary receiver (SRx) 1116. The transmitter 1112 may receive a transmit signal from a digital-to-analog converter (DAC) 1154 on a modem 1125 on the wireless communication device 1104. The transmit signal may be passed through a low pass filter (LPF) 1189 before being upconverted to a transmit frequency by an upconverter 1122. The transmitter 1112 may include a Tx phase lock loop (PLL) 1134 and a Tx voltage controlled oscillator (VCO) 1132 that are used to generate a Tx local oscillator (LO) signal. The Tx local oscillator (LO) signal may be provided to the upconverter 1122.

The upconverted transmit signal may then be amplified by an adjustable drive amplifier (DA) 1120. The output of the adjustable drive amplifier (DA) 1120 may be coupled to the input of an adjustable power amplifier (PA) 1135. The adjustable power amplifier (PA) 1135 may not be on the transceiver chip 1110.

The output of the adjustable power amplifier (PA) 1135 may be coupled to a duplexer 1133. The duplexer 1133 may utilize frequency selectivity to provide isolation between the transmitter 1112 and the primary receiver (PRx) 1114. The duplexer 1133 may also be coupled to an adjustable low noise amplifier (LNA) 1148 on the primary receiver (PRx) 1114. The duplexer 1133 may further be coupled to the radio frequency (RF) switch 1131.

The primary receiver (PRx) 1114 may also include a downconverter 1150. The downconverter 1150 may be coupled to an output of the adjustable low noise amplifier (LNA) 1148. The downconverter 1150 may receive a downconverting signal generated by an Rx voltage controlled oscillator (VCO) 1160 and an Rx phase lock loop (PLL) 1162. The output of the downconverter 1150 may be coupled to a low pass filter (LPF) 1152. The output of the low pass filter (LPF) 1152 may be coupled to an analog-to-digital converter (ADC) 1158 on the modem 1125.

The secondary receiver (SRx) 1116 may include an adjustable low noise amplifier (LNA) 1136. The input to the adjustable low noise amplifier (LNA) 1136 may be coupled to the coupler 1126. The output of the adjustable low noise amplifier (LNA) 1136 may be coupled to a downconverter 1138. The downconverter 1138 may receive the Tx local oscillator (LO) signal from the Tx voltage controlled oscillator (VCO) 1132 and Tx phase lock loop (PLL) 1134. Thus, the secondary receiver (SRx) 1116 may share the synthesizer used by the transmitter 1112.

The output of the downconverter 1138 may be coupled to a low pass filter (LPF) 1142. The output of the low pass filter (LPF) 1142 may be coupled to an analog-to-digital converter (ADC) 1156 on the modem 1125.

The transceiver chip 1110 may also include a tone generator 1124. The tone generator 1124 may be used to generate testing tones for collecting Rx automatic calibration test measurement values 129. The tone generator 1124 was discussed above in relation to FIG. 8, FIG. 9 and FIG. 10. In one configuration, if the frequency flatness of the coupler 1126 is higher than expected, a coupling 1185 may be used between the tone generator and the radio frequency (RF) connector switch 1108 (thus allowing the radio frequency (RF) connector switch 1108 to switch between coupling the antenna 1118, the call box 1106, the testing load 1127 and the tone generator 1124 to the coupler 1126). In another configuration, a coupling 1186 may be used between the tone generator 1124 and the radio frequency (RF) switch 1131.

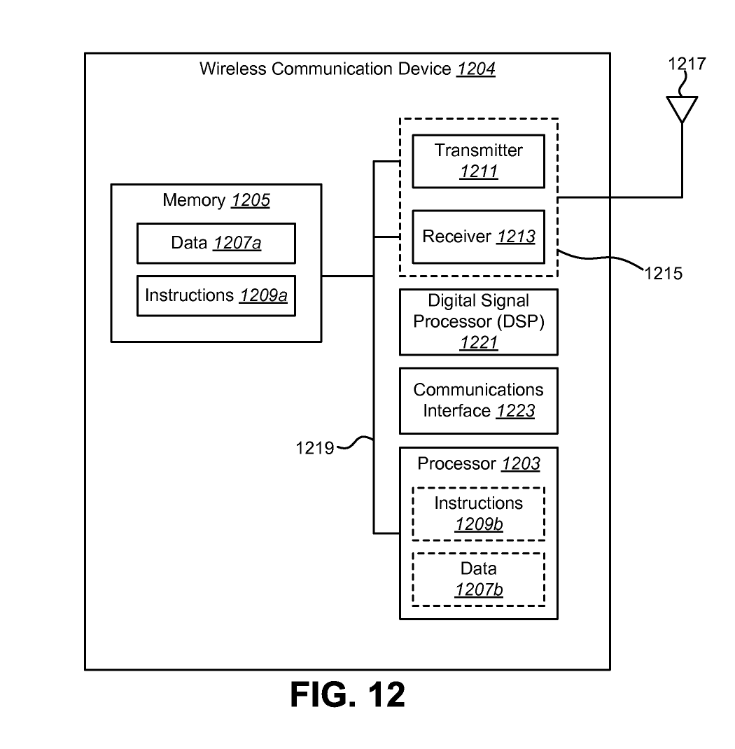

FIG. 12 illustrates certain components that may be included within a wireless communication device 1204. The wireless communication device 1204 may be an access terminal, a mobile station, a user equipment (UE), etc. The wireless communication device 1204 includes a processor 1203. The processor 1203 may be a general purpose single- or multi-chip microprocessor (e.g., an ARM), a special purpose microprocessor (e.g., a digital signal processor (DSP)), a microcontroller, a programmable gate array, etc. The processor 1203 may be referred to as a central processing unit (CPU). Although just a single processor 1203 is shown in the wireless communication device 1204 of FIG. 12, in an alternative configuration, a combination of processors (e.g., an ARM and DSP) could be used.

The wireless communication device 1204 also includes memory 1205. The memory 1205 may be any electronic component capable of storing electronic information. The memory 1205 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 1207a and instructions 1209a may be stored in the memory 1205. The instructions 1209a may be executable by the processor 1203 to implement the methods disclosed herein. Executing the instructions 1209a may involve the use of the data 1207a that is stored in the memory 1205. When the processor 1203 executes the instructions 1209, various portions of the instructions 1209b may be loaded onto the processor 1203, and various pieces of data 1207b may be loaded onto the processor 1203.

The wireless communication device 1204 may also include a transmitter 1211 and a receiver 1213 to allow transmission and reception of signals to and from the wireless communication device 1204 via an antenna 1217. The transmitter 1211 and receiver 1213 may be collectively referred to as a transceiver 1215. The wireless communication device 1204 may also include (not shown) multiple transmitters, multiple antennas, multiple receivers and/or multiple transceivers.

The wireless communication device 1204 may include a digital signal processor (DSP) 1221. The wireless communication device 1204 may also include a communications interface 1223. The communications interface 1223 may allow a user to interact with the wireless communication device 1204.

The various components of the wireless communication device 1204 may be coupled together by one or more buses, which may include a power bus, a control signal bus, a status signal bus, a data bus, etc. For the sake of clarity, the various buses are illustrated in FIG. 12 as a bus system 1219.

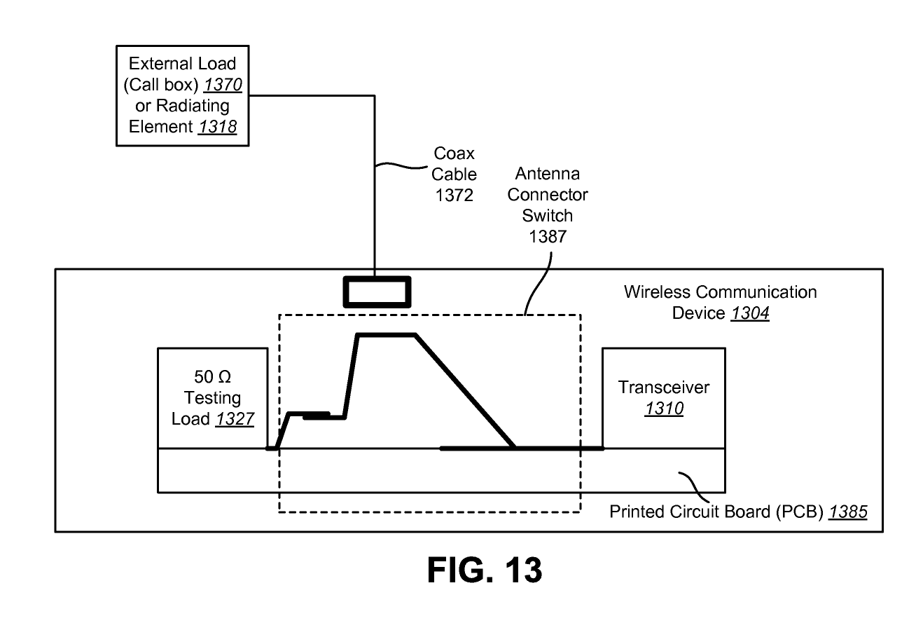

FIG. 13 is a block diagram illustrating a wireless communication device 1304 for use in the present systems and methods. The wireless communication device 1304 of FIG. 13 may be one configuration of the wireless communication device 104 of FIG. 1. Instead of a radio frequency (RF) connector switch 708, the wireless communication device 1304 may include an antenna connector switch 1387. In one configuration, the antenna connector switch 1387 may be a piece of wire that bends. In another configuration, the antenna connector switch 1387 may be a spring loaded connector. The antenna connector switch 1387 may detect an external load 1370 (such as a call box 106) or a radiating element 1318 (such as an antenna 108) coupled to the wireless communication device 1304 by a coax cable 1372.

The wireless communication device 1304 may include a transceiver 1310 and a 50Ω testing load 1327. Both the transceiver 1310 and the 50Ω testing load 1327 may be located on a printed circuit board (PCB) 1385 in the wireless communication device 1304. In one configuration, when no pressure is detected by the antenna connector switch 1387, the wiring on the printed circuit board (PCB) 1385 may couple the transceiver 1310 to the 50Ω testing load 1327.

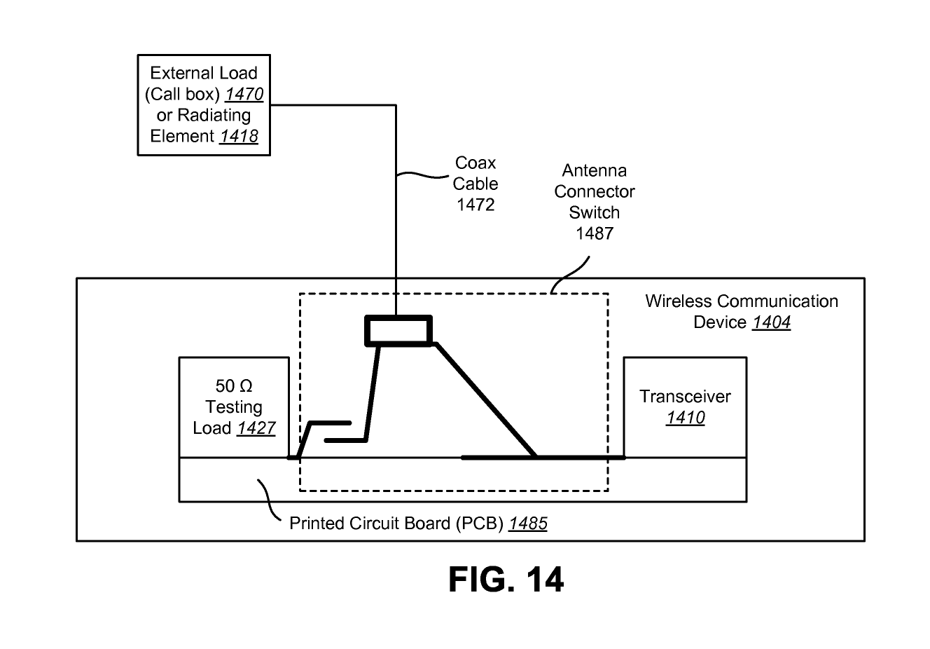

FIG. 14 is a block diagram illustrating another wireless communication device 1404 for use in the present systems and methods. The wireless communication device 1404 of FIG. 14 may be one configuration of the wireless communication device 104 of FIG. 1. Instead of a radio frequency (RF) connector switch 708, the wireless communication device 1404 may include an antenna connector switch 1487. The antenna connector switch 1487 may detect an external load 1470 (such as a call box 106) or a radiating element 1418 (such as an antenna 108) coupled to the wireless communication device 1404 by a coax cable 1472.

The wireless communication device 1404 may include a transceiver 1410 and a 50Ω testing load 1427. Both the transceiver 1410 and the 50Ω testing load 1427 may be located on a printed circuit board (PCB) 1485 in the wireless communication device 1404. In one configuration, when pressure is detected by the antenna connector switch 1487 from the coax cable 1472, the wiring on the printed circuit board (PCB) 1485 may couple the transceiver 1410 to the external load 1470 or the radiating element 1418.

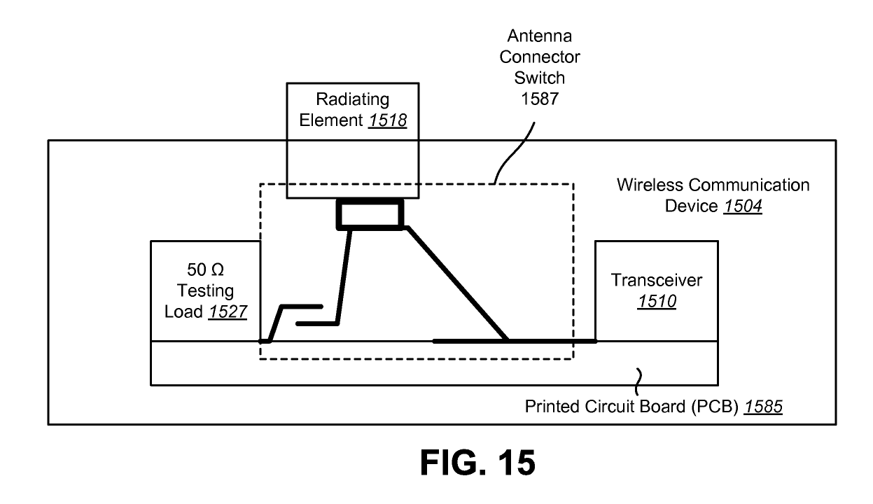

FIG. 15 is a block diagram illustrating yet another wireless communication device 1504 for use in the present systems and methods. The wireless communication device 1504 of FIG. 15 may be one configuration of the wireless communication device 104 of FIG. 1. Instead of a radio frequency (RF) connector switch 708, the wireless communication device 1504 may include an antenna connector switch 1587. The antenna connector switch 1487 may detect a radiating element 1518 (such as an antenna 108) coupled to the wireless communication device 1504.

The wireless communication device 1504 may include a transceiver 1510 and a 50Ω testing load 1527. Both the transceiver 1510 and the 50Ω testing load 1527 may be located on a printed circuit board (PCB) 1585 in the wireless communication device 1504. In one configuration, when pressure is detected by the antenna connector switch 1587 from the radiating element 1518, the wiring on the printed circuit board (PCB) 1585 may couple the transceiver 1510 to the radiating element 1518.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-Ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 3, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods and apparatus described herein without departing from the scope of the claims.

What is claimed is:

1. A wireless communication device configured for automatic calibration, comprising:
an internal testing load;
a transceiver chip; and
a radio frequency connector switch that couples circuitry on the transceiver chip to one of the internal testing load, an external load and a radiating element.

2. The wireless communication device of claim 1, wherein the wireless communication device collects test measurement values when the radio frequency connector switch couples the transceiver chip to the internal testing load.

3. The wireless communication device of claim 2, wherein the external load is a call box, and wherein the wireless communication device provides the test measurement values to the call box when the radio frequency connector switch couples the transceiver chip to the call box.

4. The wireless communication device of claim 2, wherein the test measurement values comprise Rx automatic calibration test measurement values and Tx automatic calibration test measurement values.

5. The wireless communication device of claim 4, wherein the transceiver chip comprises:
a transmitter;
a primary receiver;
a secondary receiver; and
a tone generator.

6. The wireless communication device of claim 5, wherein the radio frequency connector switch couples the circuitry on the transceiver chip to one of the internal testing load, the external load and the tone generator.

7. The wireless communication device of claim 5, wherein the tone generator comprises:
a phase lock loop;
a voltage controlled oscillator;
a drive amplifier; and
one or more attenuators, wherein the tone generator can pass a generated signal through the one or more attenuators to scale the generated signal.

8. The wireless communication device of claim 5, wherein the tone generator comprises:
a temperature compensated crystal oscillator;
an Rx local oscillator;
a divide by M circuit;
a mixer; and
one or more attenuators, wherein the tone generator can pass a generated signal through the one or more attenuators to scale the generated signal.

9. The wireless communication device of claim 8, wherein the temperature compensated crystal oscillator, the Rx local oscillator and the divide by M circuit are reused from circuitry on the transceiver chip.

10. The wireless communication device of claim 5, wherein the tone generator comprises:
a phase lock loop;
a voltage controlled oscillator, wherein the phase lock loop and voltage controlled oscillator form a feedback loop; and
one or more attenuators, wherein the tone generator can pass a generated signal through the one or more attenuators to scale the generated signal.

11. The wireless communication device of claim 5, wherein the transceiver chip further comprises a tone generator switch that couples a coupler on the wireless communication device to one of the tone generator and the secondary receiver.

12. The wireless communication device of claim 11, wherein the tone generator switch couples the tone generator to the coupler, wherein the radio frequency connector switch couples the transceiver chip to the internal testing load, and wherein Rx automatic calibration test measurement values are collected by generating a tone using the tone generator and measuring a response through the internal testing load using the primary receiver.

13. The wireless communication device of claim 11, wherein the tone generator switch couples the secondary receiver to the coupler, wherein the radio frequency connector couples the transceiver chip to the internal testing load, and wherein Tx automatic calibration test measurement values are collected by generating a transmit signal using the transmitter and measuring a response through the internal testing load using the secondary receiver.

14. The wireless communication device of claim 2, wherein the test measurement values comprise power versus frequency versus gain delta values.

15. The wireless communication device of claim 2, wherein the test measurement values are calculated autonomously by the wireless communication device prior to calibration by a call box.

16. The wireless communication device of claim 1, wherein the radiating element is an antenna.

17. The wireless communication device of claim 1, wherein the radio frequency connector switch is configured so that the transceiver chip is coupled to the internal testing load when the external load is not connected to the wireless communication device and so that the transceiver chip is coupled to the external load when the external load is connected to the wireless communication device.

18. The wireless communication device of claim 1, wherein the internal testing load is a 50Ω testing load.

19. A method for generating test measurement values by a wireless communication device, comprising:
coupling circuitry in the wireless communication device to an internal testing load;
generating test measurement values using the internal testing load;
coupling the circuitry in the wireless communication device to a call box; and
providing the test measurement values to the call box.

20. The method of claim 19, wherein generating test measurement values using the internal testing load comprises:
generating a tone using a tone generator; and
measuring a response through the internal testing load using a primary receiver, wherein the response comprises Rx automatic calibration test measurement values.

21. The method of claim 19, wherein generating test measurement values using the internal testing load comprises:
generating a transmit signal using a transmitter; and
measuring a response through the internal testing load using a secondary receiver, wherein the response comprises Tx automatic calibration test measurement values.

22. The method of claim 19, wherein the wireless communication device comprises:
the internal testing load;
a transceiver chip; and
a radio frequency connector switch that couples circuitry on the transceiver chip to one of the internal testing load, an external load and a radiating element.

23. The method of claim 22, wherein the wireless communication device collects test measurement values when the radio frequency connector switch couples the transceiver chip to the internal testing load.

24. The method of claim 23, wherein the external load is the call box, and wherein the wireless communication device provides the test measurement values to the call box when the radio frequency connector switch couples the transceiver chip to the call box.

25. The method of claim 23, wherein the test measurement values comprise Rx automatic calibration test measurement values and Tx automatic calibration test measurement values.

26. The method of claim 25, wherein the transceiver chip comprises:
a transmitter;
a primary receiver;
a secondary receiver; and
a tone generator.

27. The method of claim 26, wherein the radio frequency connector switch couples the circuitry on the transceiver chip to one of the internal testing load, the external load and the tone generator.

28. The method of claim 26, wherein the tone generator comprises:
a phase lock loop;
a voltage controlled oscillator;
a drive amplifier; and
one or more attenuators, wherein the tone generator can pass a generated signal through the one or more attenuators to scale the generated signal.

29. The method of claim 26, wherein the tone generator comprises:
a temperature compensated crystal oscillator;
an Rx local oscillator;
a divide by M circuit;
a mixer; and
one or more attenuators, wherein the tone generator can pass a generated signal through the one or more attenuators to scale the generated signal.

30. The method of claim 29, wherein the temperature compensated crystal oscillator, the Rx local oscillator and the divide by M circuit are reused from circuitry on the transceiver chip.

31. The method of claim 26, wherein the tone generator comprises:
a phase lock loop;
a voltage controlled oscillator, wherein the phase lock loop and voltage controlled oscillator form a feedback loop; and
one or more attenuators, wherein the tone generator can pass a generated signal through the one or more attenuators to scale the generated signal.

32. The method of claim 26, wherein the transceiver chip further comprises a tone generator switch that couples a coupler on the wireless communication device to one of the tone generator and the secondary receiver.

33. The method of claim 32, wherein the tone generator switch couples the tone generator to the coupler, wherein the radio frequency connector switch couples the transceiver chip to the internal testing load, and wherein Rx automatic calibration test measurement values are collected by generating a tone using the tone generator and measuring a response through the internal testing load using the primary receiver.

34. The method of claim 32, wherein the tone generator switch couples the secondary receiver to the coupler, wherein the radio frequency connector couples the transceiver chip to the internal testing load, and wherein Tx automatic calibration test measurement values are collected by generating a transmit signal using the transmitter and measuring a response through the internal testing load using the secondary receiver.

35. The method of claim 23, wherein the test measurement values comprise power versus frequency versus gain delta values.

36. The method of claim 23, wherein the test measurement values are calculated autonomously by the wireless communication device prior to calibration by a call box.

37. The method of claim 22, wherein the radiating element is an antenna.

38. The method of claim 22, wherein the radio frequency connector switch is configured so that the transceiver chip is coupled to the internal testing load when the external load is not connected to the wireless communication device and so that the transceiver chip is coupled to the external load when the external load is connected to the wireless communication device.

39. The method of claim 22, wherein the internal testing load is a 50Ω testing load.

40. An apparatus for generating test measurement values, comprising:
means for coupling circuitry in the apparatus to an internal testing load;
means for generating test measurement values using the internal testing load;
means for coupling the circuitry in the apparatus to a call box; and
means for providing the test measurement values to the call box.

41. The apparatus of claim 40, wherein the means for generating test measurement values using the internal testing load comprise:
means for generating a tone using a tone generator; and
means for measuring a response through the internal testing load using a primary receiver, wherein the response comprises Rx automatic calibration test measurement values.

42. The apparatus of claim 40, wherein the means for generating test measurement values using the internal testing load comprise:
means for generating a transmit signal using a transmitter; and
means for measuring a response through the internal testing load using a secondary receiver, wherein the response comprises Tx automatic calibration test measurement values.

43. A computer-program product for generating test measurement values, the computer-program product comprising a non-transitory computer-readable medium having instructions thereon, the instructions comprising:
code for causing a wireless communication device to couple circuitry in the wireless communication device to an internal testing load;
code for causing the wireless communication device to generate test measurement values using the internal testing load;
code for causing the wireless communication device to couple the circuitry in the wireless communication device to a call box; and
code for causing the wireless communication device to provide the test measurement values to the call box.

44. The computer-program product of claim 43, wherein the code for causing the wireless communication device to generate test measurement values using the internal testing load comprises:
code for causing the wireless communication device to generate a tone using a tone generator; and
code for causing the wireless communication device to measure a response through the internal testing load using a primary receiver, wherein the response comprises Rx automatic calibration test measurement values.

45. The computer-program product of claim 43, wherein the code for causing the wireless communication device to generate test measurement values using the internal testing load comprises:
code for causing the wireless communication device to generate a transmit signal using a transmitter; and
code for causing the wireless communication device to measure a response through the internal testing load using a secondary receiver, wherein the response comprises Tx automatic calibration test measurement values.
